(19) United States
(12) Patent Application Publication
(10) Pub. No.: US 2024/0154143 A1
(43) Pub. Date: May 9, 2024

(54) PROTONIC CERAMIC FUEL CELLS AND MANUFACTURING METHOD THEREOF

(71) Applicant: KOREA INSTITUTE OF SCIENCE AND TECHNOLOGY, Seoul (KR)

(72) Inventors: Sungeun YANG, Seoul (KR); Ho Il Ji, Seoul (KR); Yeji Lim, Seoul (KR); Jong Ho Lee, Seoul (KR); Wan-jae Lee, Seoul (KR); Junseok Kim, Seoul (KR); Ji-Won Son, Seoul (KR); Kyung Joong Yoon, Seoul (KR); Deok-Hwang Kown, Seoul (KR)

(21) Appl. No.: 18/225,218

(22) Filed: Jul. 24, 2023

(30) Foreign Application Priority Data
Nov. 9, 2022 (KR) 10-2022-0148957

(51) Int. Cl. H01M 8/1253; H01M 4/90; H01M 8/1213; H01M 8/126

(52) U.S. Cl. CPC H01M 8/1253; H01M 4/9033; H01M 8/1213; H01M 8/126

(57) ABSTRACT

In an embodiment of the present invention, a proton conductive oxide fuel cell comprising an electrode substrate, a proton conductive oxide electrolyte layer positioned on the electrode substrate, a proton conductive oxide reaction prevention layer positioned on the electrolyte layer, and a proton conductive oxide air electrode layer positioned on the reaction prevention layer, wherein the reaction prevention layer is composed of ABO_{3-δ} structured perovskite proton conductive oxide, may be provided.

### CROSS-REFERENCE TO RELATED APPLICATION

This application claims priority to and the benefit of Korean Patent Application No. 10-2022-0148957 filed in the Korean Intellectual Property Office on Nov. 9, 2022, the entire contents of which are incorporated herein by reference.

### BACKGROUND OF THE INVENTION

### (a) Field of the Invention

The embodiment of the present invention relates to a proton conductive oxide fuel cell and manufacturing method thereof. Specifically, it concerns a proton conductive oxide fuel cell with improved durability equipped with a proton conductive oxide reaction prevention layer between the electrolyte layer and the cathode (air electrode) layer, and its manufacturing method.

### (b) Description of the Related Art

A fuel cell, a device that converts chemical energy of fuel into electrical energy, is considered one of the future energy sources to replace conventional internal combustion engines due to its high conversion efficiency and environmentally friendly characteristics. Among them, the Solid Oxide Fuel Cell (SOFC) has the highest theoretical efficiency, can use a variety of carbon-hydrogen based fuels, and due to its high operating temperature, has the merit of not needing to use a noble metal catalyst. However, Solid Oxide Fuel Cells (SOFCs) primarily use oxygen ion conductors as electrolyte materials, which leads to a very high operation temperature. This results in an increase in system costs, and issues with durability and reliability. To solve the aforementioned problems, the Proton Conductive Oxide Fuel Cell (Protonic Ceramic Fuel Cell, PCFC), which uses a proton conductor or proton conductive oxide with excellent electrical properties and a high ionic transport coefficient in the medium-low temperature range, has been developed as an electrolyte. Generally, the electrolyte used in proton conductive oxide fuel cells is based on the perovskite structures of BaCeO3 or BaZrO3, however, Ba is chemically unstable, which leads to a problem of easy precipitation during the operation of the fuel cell. Moreover, there is a problem where the degradation of the fuel cell is accelerated by the material precipitated between the electrolyte layer and the cathode (air electrode) layer.

Therefore, it is urgent to develop a proton conductive oxide fuel cell with improved durability that can solve the aforementioned problems.

### SUMMARY OF THE INVENTION

In an exemplary embodiment, it is intended to provide a proton conductive oxide fuel cell with improved durability that includes a reaction prevention layer between the electrolyte and air electrode layers to solve the aforementioned problems.

In another exemplary embodiment of the present invention, it is intended to provide a manufacturing method of a proton conductive fuel cell with improved durability.

According to an exemplary embodiment, a proton conductive oxide fuel cell may comprise a fuel electrode substrate, a proton conductive oxide electrolyte layer positioned on the fuel electrode substrate, a proton conductive oxide reaction prevention layer positioned on the electrolyte layer, and a proton conductive oxide air electrode layer positioned on the reaction prevention layer, wherein the reaction prevention layer may be composed of perovskite proton conductive oxide.

The reaction prevention layer may be a ABO_{3-δ} structured perovskite proton conductive oxide, the A site may comprise one or more types selected from alkali earth metals or lanthanide-based metals, and specifically comprise one to three selected from Barium (Ba), Praseodymium (Pr), or Strontium (Sr).

The B site of the ABO_{3-δ} structured perovskite proton conductive oxide may comprise one or more selected from transition metals or lanthanide-based metals, and specifically comprise one to three selected from Nickel (Ni), Cobalt (Co), Iron (Fe), Zirconium (Zr), Cerium (Ce), Yttrium (Y), or Ytterbium (Yb), and more specifically comprise two to three selected from Nickel (Ni), Cobalt (Co), or Iron (Fe).

The perovskite ABO_{3-δ} structured perovskite proton conductive oxide may be represented by the following Chemical Formula 1:

PrNiₓCo₁₋ₓO₃(0.3≤x≤0.7) [Chemical Formula 1]

Furthermore, the reaction prevention layer may have an average thickness in the range of 100 nm to 500 nm, and the air electrode layer may be a perovskite proton conductive oxide comprising Strontium (Sr)-Cobalt (Co)-Iron (Fe) oxides.

On the other hand, the electrolyte layer may comprise barium zirconate-cerate doped with two or more rare earth metals, and the rare earth metals may be Yttrium (Y) and Ytterbium (Yb).

In another exemplary embodiment of the present invention, a method for manufacturing a proton conductive oxide fuel cell may comprise preparing an electrode substrate, forming an electrolyte layer comprising a barium-zirconate-barium cerate doped with two or more rare earth metals on the electrode substrate, forming a proton conductive oxide reaction prevention layer on the electrolyte layer, and forming an air electrode layer on the proton conductive oxide reaction prevention layer.

The step of forming the proton conductive oxide reaction prevention layer on the electrolyte layer may be to form the reaction prevention layer using ABO_{3-δ} structured perovskite proton conductive oxide. The A site of the ABO_{3-δ} structured perovskite proton conductive oxide may comprise one or more types selected from alkali earth metals or lanthanide-based metals, and comprise one to three selected from Barium (Ba), Praseodymium (Pr), or Strontium (Sr). The B site of the ABO_{3-δ} structured perovskite proton conductive oxide may comprise one or more selected from transition metals or lanthanide-based metals, and comprise one to three selected from Nickel (Ni), Cobalt (Co), Iron (Fe), Zirconium (Zr), Cerium (Ce), Yttrium (Y), or Ytterbium (Yb), and more specifically comprise two to three selected from Nickel (Ni), Cobalt (Co), or Iron (Fe). The perovskite ABO_{3-δ} structured perovskite proton conductive oxide may be represented by the following Chemical Formula 1:

PrNiₓCo₁₋ₓO₃(0.3≤x≤0.7) [Chemical Formula 1]

The step of forming the proton conductive oxide reaction prevention layer on the electrolyte layer may be to form a reaction prevention layer having an average thickness within the range of 100 nm to 500 nm.

The step of forming the proton conductive oxide reaction prevention layer on the electrolyte layer may be one of the group consisting of physical vapor deposition (PVD), chemical vapor deposition (CVD), chemical solution deposition (CSD), and spray pyrolysis.

In the step of forming the air electrode layer on the proton conductive oxide reaction prevention layer, the air electrode layer may be formed using a perovskite oxide comprising strontium (Sr)-cobalt (Co)-iron (Fe) oxides.

In the step of forming the electrolyte layer comprising a barium zirconate-cerate doped with two or more rare earth metals on the electrode substrate, the rare earth metals may be yttrium (Y) and ytterbium (Yb).

A proton conductive oxide fuel cell comprising a reaction prevention layer between the electrolyte layer and air electrode layer according to an exemplary embodiment has the advantages of improved thermal characteristics and enhanced durability.

In another exemplary embodiment of the present invention, there is an advantage of being able to manufacture a proton conductive fuel cell with enhanced durability by forming an oxide dense film with proton conductivity between the electrolyte layer and the air electrode layer of the fuel cell.

### BRIEF DESCRIPTION OF THE DRAWINGS

FIG. 1 is a schematic cross-sectional view of a proton conductive oxide fuel cell according to an exemplary embodiment.

FIG. 2 represents the result of a cross-sectional SEM analysis of the air electrode layer—reaction prevention layer—electrolyte layer of a fuel cell manufactured according to Example 1.

FIG. 3 represents the result of a cross-sectional SEM analysis of the reaction prevention layer formed on the electrolyte layer in the process of manufacturing a fuel cell according to Example 1.

FIG. 4 represents the change in voltage of the fuel cell during operation at a current density of 0.5 A cm′, according to Example 1 and Comparative Example 1.

FIG. 5 represents cross-sectional SEM analysis images of the fuel cells according to Example 1 and Comparative Example 1, after the performance test.

FIG. 6 represents the change in voltage of the fuel cells according to Examples 1 to 3 and Comparative Example 1.

### DETAILED DESCRIPTION OF THE EMBODIMENTS

In the specification of the present invention, terms such as “first,” “second,” and “third” are used to describe various parts, components, regions, layers, and/or sections, but they are not limited to these. These terms are used solely to distinguish one part, component, region, layer, or section from another. Therefore, the first part, component, region, layer, or section described below may be referred to as the second part, component, region, layer, or section within the scope not departing from the range of the present invention.

The specialized terms used herein are merely for the purpose of referencing certain exemplary embodiments, and are not intended to limit the scope of the present invention. The singular forms used herein also encompass plural forms, unless the phrasing clearly indicates the contrary. The term “comprising” used in the specification means specifying certain characteristics, regions, integers, steps, operations, elements, and/or components, and does not exclude the presence or addition of other characteristics, regions, integers, steps, operations, elements, and/or components.

When it is mentioned that one part is “on” or “above” another part, it can either be directly on or above the other part, or another part may intervene between them. Conversely, when it is mentioned that one part is “directly above” another part, no other part is present in between.

Unless defined otherwise, all terms including technical and scientific terms used herein have the same meaning as commonly understood by one of ordinary skill in the art to which the present invention belongs. Terms defined in commonly used dictionaries are interpreted as having a meaning that is consistent with their meaning in the context of the related technical literature and the present disclosure, and are not interpreted as ideal or excessively formal unless explicitly defined otherwise.

In the following, a detailed description of an exemplary embodiment will be provided. However, this is provided as an example, and it does not limit the present invention, which is defined solely by the scope of the claims that will be described later. Moreover, throughout the specification of the present invention, the proton conductive oxide may be a triple conductive oxide that conducts protons, electrons, and oxygen ions.

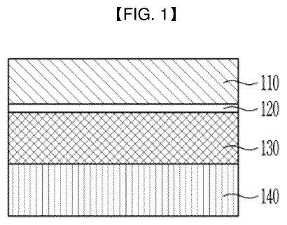

FIG. 1 is a schematic cross-sectional view of a proton conductive oxide fuel cell according to an exemplary embodiment.

Referring to FIG. 1, a proton conductive oxide fuel cell according to an exemplary embodiment may comprise a fuel electrode substrate 140, a proton conductive oxide electrolyte layer 130 positioned on the fuel electrode substrate, a proton conductive oxide reaction prevention layer 120 positioned on the electrolyte layer, and a proton conductive oxide air electrode layer 110 positioned on the reaction prevention layer.

The reaction prevention layer 120 may be composed of a perovskite proton conductive oxide, specifically, it may be a ABO_{3-δ} structured perovskite proton conductive oxide.

In this case, the A site of the ABO_{3-δ} structured perovskite proton conductive oxide may comprise one or more selected from alkali earth metals or lanthanide metals. More specifically, it may include one to three species, and even more specifically, it may comprise one to three species selected from barium (Ba), praseodymium (Pr), or strontium (Sr).

Also, the B site of the ABO_{3-δ} structured perovskite proton conductive oxide may comprise one or more selected from transition metals or lanthanide metals. Specifically, it may comprise one to three selected from nickel (Ni), cobalt (Co), iron (Fe), zirconium (Zr), cerium (Ce), yttrium (Y), or ytterbium (Yb). Even more specifically, it may comprise 2 to 3 species selected from nickel (Ni), cobalt (Co), or iron (Fe).

The ABO_{3-δ} structured perovskite proton conductive oxide may specifically be expressed by the following Chemical Formula 1.

PrNiₓCo₁₋ₓO₃(0.3≤x≤0.7) [Chemical Formula 1]

Additionally, the ABO_{3-δ} structured perovskite proton conductive oxide may specifically be yttria-doped barium cerate (BCY) represented by the following Chemical Formula 2, or a solid solution of yttria-doped barium zirconate and barium cerate (BZCY) represented by Chemical Formula 3.

BaZr₁₋ₓYₓO₃(x≤0.2) [Chemical Formula 2]

BaZr_{1-x-y-z}Ce_{y}YₓYb_{z}O₃(x+z≤0.2, 0.1≤y≤0.7) [Chemical Formula 3]

Meanwhile, the perovskite proton conductive oxide that composes the reaction prevention layer 120 may be a triple conductive oxide, which has all three conductivities: proton conductivity, oxygen ion conductivity, and electron conductivity. Specifically, it may be a double perovskite structure of AA′B₂O_{5+δ} or a Ruddlesden-Popper structure of Aₙ₊₁BₙO₃ₙ₊₁. The A site and B site may include one or more selected from barium (Ba), praseodymium (Pr), strontium (Sr), iron (Fe), zirconium (Zr), copper (Cu), zinc (Zn), nickel (Ni), cobalt (Co), or manganese (Mn).

Moreover, the perovskite proton conductive oxide may be more specifically BaZr_{0.8}Y_{0.2}O_{3-δ}.

Meanwhile, the proton conductive oxide reaction prevention layer 120 may have an average thickness in the range of 50 nm to 1000 nm, and more specifically, in the range of 100 nm to 500 nm. If the thickness of the reaction prevention layer 120 is within the aforementioned range, the effect of improving the durability of the fuel cell may be achieved, and also the issue of the fuel cell performance and energy density being deteriorated due to the reaction prevention layer being too thick may be prevented.

The fuel electrode substrate 140 comprises a fuel electrode functional layer, has sufficient strength and chemical stability to withstand damage during the fuel cell manufacturing process, and is a cermet that may suppress the agglomeration of metal, being a mixture of metal and metal oxide. Examples of the metal oxide may comprise one or more selected from a group consisting of doped barium zirconate, doped barium cerate, and doped barium zirconate-cerate, more specifically, it may be doped with rare earth metals, and more specifically, it may be doped with two or more types of rare earth metals. Meanwhile, the rare earth metal may be yttrium (Y) and ytterbia (Yb). In addition, it may be one or more selected from a group consisting of doped zirconia, doped ceria, and doped lanthanum gallate, and more preferably, it may be one or more selected from a group consisting of yttria-stabilized zirconia (YSZ), gadolinia or samaria-doped ceria (GDC, SDC), and lanthanum gallate doped with strontium oxide and magnesium oxide (LSGM). For example, the metal material may comprise one or more metal catalysts selected from a group consisting of nickel, ruthenium, palladium, rhodium, and platinum. The metal catalyst may be any one or more selected from the group consisting of nickel, ruthenium, palladium, rhodium, and platinum.

The electrolyte layer 130 may be a proton conductive oxide and may be one or more selected from the group comprising doped barium zirconate, doped barium cerate and doped barium zirconate-cerate. More specifically, it may be doped with a rare earth metal, and more specifically, it may be doped with two or more kinds of rare earth metals. Meanwhile, the rare earth metal may be yttrium (Y) and ytterbium (Yb).

The air electrode layer 110 may be an electron conductive oxide as a perovskite material comprising strontium (Sr)-cobalt (Co)-iron (Fe) oxide, may be a mixed conductive oxide conducting electrons and oxygen ions, and may also be a triple conductive oxide conducting electrons, oxygen ions, and protons.

Another exemplary embodiment of the present invention may provide a method for manufacturing a proton conductive oxide fuel cell.

In another exemplary embodiment of the present invention, a method for manufacturing a proton conductive oxide fuel cell may comprise preparing an electrode substrate, forming an electrolyte layer comprising a barium-zirconate-barium cerate doped with two or more rare earth metals on the electrode substrate, forming a proton conductive oxide reaction prevention layer on the electrolyte layer, and forming an air electrode layer on the proton conductive oxide reaction prevention layer.

The step of preparing the fuel electrode substrate may utilize a powder process for the fuel electrode substrate comprising a porous composite, where the powder process may be tape casting or powder pressing, or screen printing.

Additionally, the fuel electrode substrate may greatly influence the densification and defect formation of the intermediate layer and the electrolyte layer during the manufacturing process. Therefore, the porous composite comprised in the fuel electrode substrate may have sufficient strength and chemical stability to not be damaged in the high temperature sintering process. It is not limited to this if it is an electronically conductive hetero material that may suppress the coarsening of metal.

The fuel electrode substrate comprises a fuel electrode functional layer, may have sufficient strength and chemical stability not to be damaged during the fuel cell manufacturing process, and may be a metal and metal oxide mixture material (cermet) that can suppress the coarsening of metal. Examples of the metal oxide may be one or more selected from the group consisting of doped barium zirconate, doped barium cerate and doped barium zirconate-cerate. More specifically, it may be doped with a rare earth metal, and more specifically, it may be doped with two or more kinds of rare earth metals. Meanwhile, the rare earth metal may be yttrium (Y) and ytterbium (Yb). In addition, it may be one or more selected from the group consisting of doped zirconia, doped ceria, and doped lanthanum gallate, and more preferably, it may be one or more selected from the group consisting of yttria-stabilized zirconia (YSZ), gadolinia or samaria-doped ceria (GDC, SDC), and lanthanum gallate doped with strontium oxide and magnesium oxide (LSGM). Examples of the metal material may comprise one or more metal catalysts selected from the group consisting of nickel, ruthenium, palladium, rhodium, and platinum. The metal catalyst may be one or more selected from the group consisting of nickel, ruthenium, palladium, rhodium, and platinum.

Continuing, an electrolyte layer may be formed on the fuel electrode substrate by a powder process and a thin film process. The method for forming the electrolyte layer may be one selected from a group consisting of tape casting, powder pressing, screen printing, physical vapor deposition (PVD), chemical vapor deposition (CVD), chemical solution deposition (CSD), and spray pyrolysis. More specifically, it may be screen printing or physical vapor deposition (PVD), and even more specifically, it may be pulsed laser deposition (PLD). In the present invention, there is an advantage of being able to uniformly adjust a certain thickness by forming the electrolyte layer using the above method. The material for forming the electrolyte layer may be a proton conductive oxide, and may be one or more selected from a group consisting of doped barium zirconate, doped barium cerate and doped barium zirconate-cerate, specifically may be doped with a rare earth metal, and more specifically may be doped with two or more kinds of rare earth metals. Meanwhile, the rare earth metals may include yttrium (Y) and ytterbia (Yb).

Furthermore, a reaction prevention layer may be formed on the electrolyte layer through powder processing and thin film processing. The method for forming the reaction prevention layer may be any one selected from a group consisting of tape casting, powder pressing, screen printing, physical vapor deposition (PVD), chemical vapor deposition (CVD), chemical solution deposition (CSD), and spray pyrolysis, and specifically it may be physical vapor deposition (PVD), and more specifically, it may be pulsed laser deposition (PLD). In the present invention, by forming the reaction prevention layer using the above method, there is an advantage that a certain thickness may be uniformly controlled.

The reaction prevention layer may be formed using a perovskite proton conductive oxide, and the perovskite proton conductive oxide may specifically be a ABO_{3-δ} structured perovskite proton conductive oxide.

In this case, the A site of the ABO_{3-δ} structured perovskite proton conductive oxide may comprise one or more selected from alkali earth metals or lanthanide metals, specifically may comprise one to three types, and more specifically may comprise one to three selected from barium (Ba), praseodymium (Pr) or strontium (Sr).

In addition, the B site of the ABO_{3-δ} structured perovskite proton conductive oxide may comprise one or more selected from transition metals or lanthanide metals, specifically may comprise from one to three selected from nickel (Ni), cobalt (Co), iron (Fe), zirconium (Zr), cerium (Ce), yttrium (Y) or ytterbium (Yb), and more specifically may comprise from two to three selected from nickel (Ni), cobalt (Co) or iron (Fe).

The ABO_{3-δ} structured perovskite proton conductive oxide may be specifically represented by the following Chemical Formula 1.

PrNiₓCo₁₋ₓO₃(0.3≤x≤0.7) [Chemical Formula 1]

Additionally, the ABO_{3-δ} structured perovskite proton conductive oxide may specifically be yttria-doped barium cerate (BCY) represented by the following Chemical Formula 2, or a solid solution of yttria-doped barium zirconate and barium cerate (BZCY) represented by Chemical Formula 3.

BaZr₁₋ₓYₓO₃(x≤0.2) [Chemical Formula 2]

BaZr_{1-x-y-z}Ce_{y}YₓYb_{z}O₃(x+z≤0.2, 0.1≤y≤0.7) [Chemical Formula 3]

Meanwhile, the perovskite proton conductive oxide that composes the reaction prevention layer 120 may be a triple conductive oxide, which has all three conductivities: proton conductivity, oxygen ion conductivity, and electron conductivity. Specifically, it may be a double perovskite structure of AA′B₂O_{5+δ} or a Ruddlesden-Popper structure of Aₙ₊₁BnO₃ₙ₊₁. The A site and B site may include one or more selected from barium (Ba), praseodymium (Pr), strontium (Sr), iron (Fe), zirconium (Zr), copper (Cu), zinc (Zn), nickel (Ni), cobalt (Co), or manganese (Mn). Moreover, the perovskite proton conductive oxide may be more specifically BaZr_{0.8}Y_{0.2}O_{3-δ}.

Meanwhile, in the present invention, the reaction prevention layer may be formed in the range of an average thickness of 50 nm to 1000 nm, and more specifically, it may be formed in the range of 100 nm to 500 nm.

Next, an air electrode layer may be formed on the reaction prevention layer, and it may be formed by the same method as forming the electrolyte layer. The air electrode layer may be an electron conductive oxide comprising a perovskite material comprising strontium (Sr)-cobalt (Co)-iron (Fe) oxide, it may be a mixed conductive oxide that conducts electrons and oxygen ions, and it may also be a triple conductive oxide that conducts electrons, oxygen ions, and protons.

The following examples illustrate the present invention in more detail. However, the following exemplary embodiment is merely a preferred embodiment of the present invention, and the present invention is not limited to the following exemplary embodiment.

### Example 1

The NiO (from Mechema) powder was mixed with BaCe_{0.4}Zr_{0.4}Y_{0.1}Yb_{0.1}O₃ (KCeracell) powder and PMMA (from Sunjin Beauty Science) powder, and after 24 hours of ball milling, a round pellet was formed under a pressure of 50 MPa. The formed pellet was sintered at 950° C. to fabricate a fuel electrode substrate. The functional layer of the fuel electrode and the BaCe_{0.4}Zr_{0.4}Y_{0.1}Yb_{0.1}O₃ electrolyte layer were formed on the fuel electrode substrate through a powder process called screen printing. The paste used for screen printing is as follows. The fuel electrode functional layer paste was prepared by milling NiO powder and BCZYYb powder mixed with α-terpineol (from Daejoong Chemical), dispersant (KD-6, from Croda), binder (BH3, from Sekisui Chemical), and plasticizer (DBP, from Junsei, Japan) for 48 hours. The electrolyte layer paste was prepared using α-terpineol as a solvent and KD-6, BH3, and DBP as additives. The screen-printed fuel electrode substrate underwent a sintering process for 4 hours at 1400° C. Next, a PrBa_{0.5}Sr_{0.5}Co_{1.5}Fe_{0.5} reaction prevention layer with an average thickness of 100 nm was formed on the BaCe_{0.4}Zr_{0.4}Y_{0.1}Yb_{0.1}O₃ electrolyte layer using the pulse laser deposition method (PLD). Finally, a PrBa_{0.5}Sr_{0.5}Co_{1.5}Fe_{0.5} air electrode layer was screen-printed on the reaction prevention layer, and it was sintered for 5 hours at 950° C. to manufacture the final proton conductive oxide fuel cell. The air electrode layer paste was manufactured using the same method as the electrolyte layer paste.

### Example 2

Except for the reaction prevention layer with an average thickness of 300 nm, a proton conductive oxide fuel cell was manufactured using the same method as Example 1.

### Example 3

Except for the reaction prevention layer with an average thickness of 500 nm, a proton conductive oxide fuel cell was manufactured using the same method as Example 1.

### Comparative Example 1

Except for not forming the reaction prevention layer, a proton conductive oxide fuel cell was manufactured using the same method as Example 1.

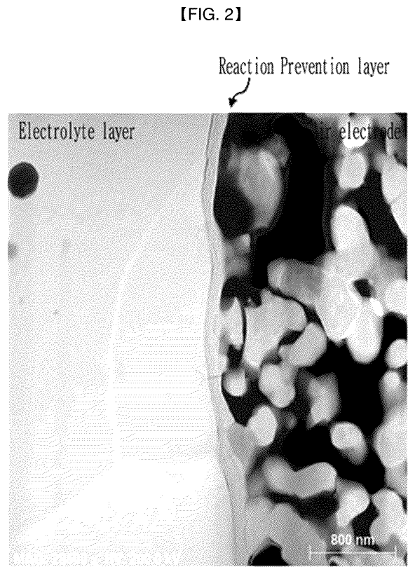

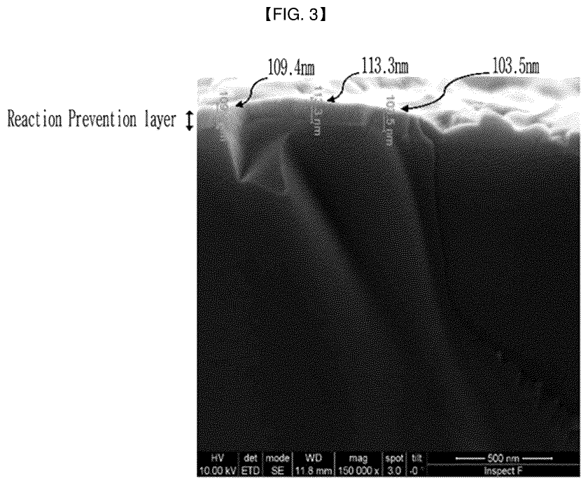

FIG. 2 shows the cross-sectional SEM analysis results of the air electrode layer-reaction prevention layer-electrolyte layer of the fuel cell manufactured according to Example 1, and FIG. 3 shows the cross-sectional SEM analysis results of the reaction prevention layer formed on the electrolyte layer in the process of manufacturing the fuel cell according to Example 1.

Referring to FIGS. 2 and 3, it may be confirmed that a reaction prevention layer of uniform thickness is densely formed between the air electrode layer and the electrolyte layer, and the thickness of the reaction prevention layer is about 100 nm.

### Experimental Example 1

In the present invention, a performance evaluation of the fuel cells manufactured according to the Examples and Comparative Example are conducted. The performance evaluation of the fuel cell was conducted on a testing jig made of Inconel 600 alloy metal, and gas supply and discharge occurred through SUS410 metal tubing. To prevent gas leakage, a glass-based sealant was used, which was compressed along with the cell. Ni foam and gold mesh were used as current collectors for the fuel electrode and the air electrode, respectively. Hydrogen fuel (200 sccm) and compressed air (200 sccm) were respectively injected into the fuel electrode and the air electrode. At 600° C., a current density of 0.5 A·cm⁻² was applied and the voltage change of the fuel cell at this time was measured.

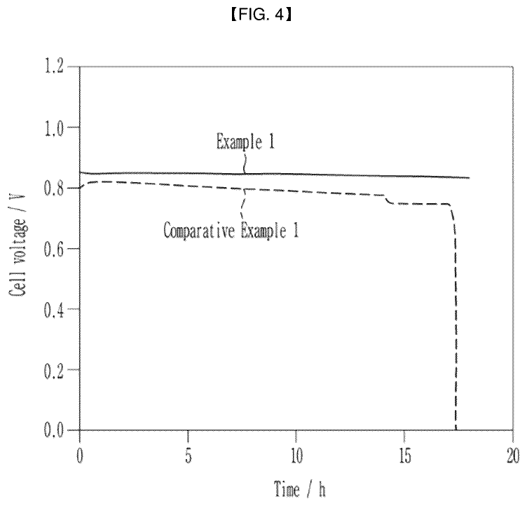

FIG. 4 represents the voltage changes in the fuel cell according to Example 1 and Comparative Example 1.

Referring to FIG. 4, in the case of Example 1, the voltage was stably maintained at about 0.85V with almost no change, whereas in Comparative Example 1, the voltage showed a tendency to gradually decrease from an initial value of about 0.82V, and after 17 hours, the voltage was not measured. This is presumed to be due to the degradation of the fuel cell after 17 hours in the case of Comparative Example 1.

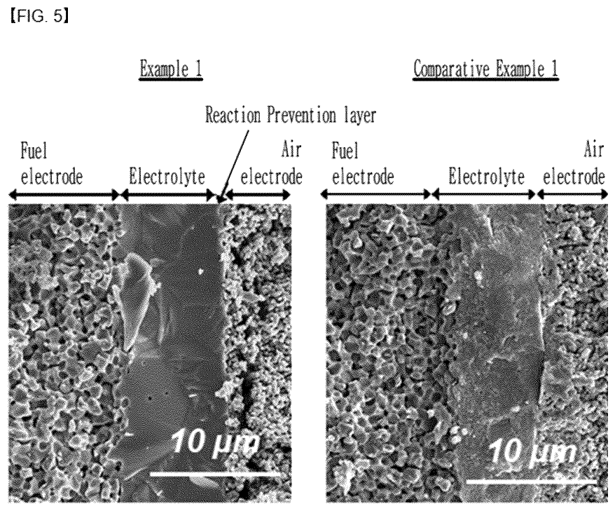

FIG. 5 shows the cross-sectional SEM analysis images of the fuel cells manufactured according to Example 1 and Comparative Example 1, after the performance test.

Referring to FIG. 5, the fuel cell according to Comparative Example 1 shows that the electrolyte has completely decomposed and the performance has deteriorated, while the fuel cell according to Example 1 maintains the electrolyte densely, and there are almost no changes in the microstructure.

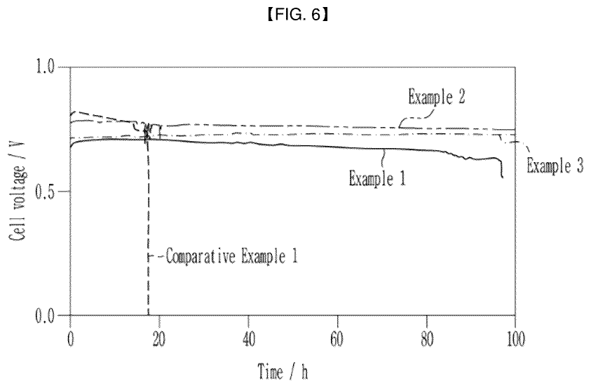

FIG. 6 represents the voltage changes of the fuel cell according to Examples 1 to 3 and Comparative Example 1.

During the 100-hour performance test, the voltage of the fuel cell according to Example 1 showed a trend of gradually decreasing after 20 hours, and after 95 hours, it exhibited a phenomenon of rapid deterioration in voltage. On the other hand, the voltage of the fuel cell according to Example 2 to 3 appeared to not change significantly, and in the case of Example 3, the voltage retention rate was more excellent compared to Example 2.

In the case of Comparative Example 1, the voltage decrease speed appeared to be 2.4 V/kh, in the case of Example 1 it was 0.576 V/kh, for Example 2 it was 0.33 V/kh, and for Example 3 it was 0.07 V/kh.

From this, in the case of the fuel cell introduced with the reaction prevention layer according to the present invention, it may be confirmed that the degradation characteristics have improved and the durability has improved, compared to the fuel cell that did not introduce the reaction prevention layer. Additionally, it may be confirmed that the thicker the thickness of the reaction prevention layer, the more improved the durability of the fuel cell.

The present invention is not limited to the exemplary embodiments but can be manufactured in various different forms, and a person of ordinary skill in the art to which the present invention pertains can understand that it can be implemented in other specific forms without changing the technical idea or essential features of the present invention. Therefore, the exemplary embodiments described above should be understood as being illustrative in all aspects, not restrictive.

### DESCRIPTION OF SYMBOLS

110: Air electrode layer
120: Reaction prevention layer
130: Electrolyte layer
140: Fuel electrode substrate

What is claimed is:

1. A proton conductive oxide fuel cell, comprising:
a fuel electrode substrate;
a proton conductive oxide electrolyte layer positioned on the fuel electrode substrate;
a proton conductive oxide reaction prevention layer positioned on the electrolyte layer; and
a proton conductive oxide air electrode layer positioned on the reaction prevention layer;
wherein the reaction prevention layer is composed of perovskite proton conductive oxide.

2. The proton conductive oxide fuel cell of claim 1, wherein
the reaction prevention layer is a ABO_{3-δ} structured perovskite proton conductive oxide.

3. The proton conductive oxide fuel cell of claim 2, wherein
the A site of the ABO_{3-δ} structured perovskite proton conductive oxide comprises one or more types selected from alkali earth metals or lanthanide-based metals.

4. The proton conductive oxide fuel cell of claim 3, wherein
the A site comprises
one to three selected from Barium (Ba), Praseodymium (Pr), or Strontium (Sr).

5. The proton conductive oxide fuel cell of claim 2, wherein
the B site of the ABO_{3-δ} structured perovskite proton conductive oxide comprises
one or more selected from transition metals or lanthanide-based metals.

6. The proton conductive oxide fuel cell of claim 5, wherein
the B site comprises
one to three selected from Nickel (Ni), Cobalt (Co), Iron (Fe), Zirconium (Zr), Cerium (Ce), Yttrium (Y), or Ytterbium (Yb).

7. The proton conductive oxide fuel cell of claim 6, wherein
the B site comprises two to three selected from Nickel (Ni), Cobalt (Co), or Iron (Fe).

8. The proton conductive oxide fuel cell of claim 7, wherein
the ABO_{3-δ} structured perovskite proton conductive oxide is represented by the following Chemical Formula 1:
PrNiₓCo₁₋ₓO₃(0.3≤x≤0.7) [Chemical Formula 1]

9. The proton conductive oxide fuel cell of claim 1, wherein
the reaction prevention layer has an average thickness within the range of 100 nm to 500 nm.

10. The proton conductive oxide fuel cell of claim 1, wherein
the air electrode layer is a perovskite proton conductive oxide comprising strontium (Sr)-cobalt (Co)-iron (Fe) oxides.

11. The proton conductive oxide fuel cell of claim 1, wherein
the electrolyte layer comprises a barium zirconate-cerate doped with two or more rare earth metals.

12. The proton conductive oxide fuel cell of claim 11, wherein
the rare earth metals are Yttrium (Y) and Ytterbium (Yb).

13. A method for manufacturing a proton conductive oxide fuel cell, comprising:
preparing an electrode substrate;
forming an electrolyte layer comprising a barium-zirconate-barium cerate doped with two or more rare earth metals on the electrode substrate;
forming a proton conductive oxide reaction prevention layer on the electrolyte layer; and
forming an air electrode layer on the proton conductive oxide reaction prevention layer.

14. The method of claim 13, wherein
the step of forming the proton conductive oxide reaction prevention layer on the electrolyte layer
is to form the reaction prevention layer using ABO_{3-δ} structured perovskite proton conductive oxide.

15. The method of claim 14, wherein
the A site of the ABO_{3-δ} structured perovskite proton conductive oxide comprises one or more types selected from alkali earth metals or lanthanide-based metals.

16. The method of claim 15, wherein
the A site comprises
one to three selected from Barium (Ba), Praseodymium (Pr), or Strontium (Sr).

17. The method of claim 14, wherein
the B site of the ABO_{3-δ} structured perovskite proton conductive oxide comprises
one or more selected from transition metals or lanthanide-based metals.

18. The method of claim 17, wherein
the B site comprises
one to three selected from Nickel (Ni), Cobalt (Co), Iron (Fe), Zirconium (Zr), Cerium (Ce), Yttrium (Y), or Ytterbium (Yb).

19. The method of claim 18, wherein
the B site comprises two to three selected from Nickel (Ni), Cobalt (Co), or Iron (Fe).

20. The method of claim 14, wherein
the ABO_{3-δ} structured perovskite proton conductive oxide is represented by the following Chemical Formula 1:
PrNiₓCo₁₋ₓO₃(0.3≤x≤0.7) [Chemical Formula 1]

21. The method of claim 13, wherein:
the step of forming the proton conductive oxide reaction prevention layer on the electrolyte layer is
to form a reaction prevention layer having an average thickness within the range of 100 nm to 500 nm.

22. The method of claim 13, wherein
the step of forming the proton conductive oxide reaction prevention layer on the electrolyte layer is
one of the group consisting of physical vapor deposition (PVD), chemical vapor deposition (CVD), chemical solution deposition (CSD), and spray pyrolysis.

23. The method of claim 13, wherein
in the step of forming the air electrode layer on the proton conductive oxide reaction prevention layer,
the air electrode layer is formed using a perovskite oxide comprising strontium (Sr)-cobalt (Co)-iron (Fe) oxides.

24. The method of claim 13, wherein
in the step of forming the electrolyte layer comprising a barium zirconate-cerate doped with two or more rare earth metals on the electrode substrate,
the rare earth metals are yttrium (Y) and ytterbium (Yb).
